(19) United States
(12) Patent Application Publication
(10) Pub. No.: US 2012/0162502 A1
(43) Pub. Date: Jun. 28, 2012

(54) CAMERA MODULE SOCKET DEVICE

(75) Inventors: Yong LEE, Anyang-si (KR); Hong Suk CHOI, Gumi-si (KR); Ji Suk KWON, Yongin-si (KR); Dae Sung HA, Seoul (KR); Min Seo KIM, Suwon-si (KR)

(73) Assignee: SAMSUNG ELECTRONICS CO. LTD., Suwon-si (KR)

(21) Appl. No.: 13/334,972

(22) Filed: Dec. 22, 2011

(30) Foreign Application Priority Data
Dec. 22, 2010 (KR) 10-2010-0132146

(51) Int. Cl. H04N 5/225

(52) U.S. Cl. 348/374; 348/E05.025

(57) ABSTRACT

A camera module socket device for blocking a path through which foreign materials may ingress is provided. The camera module socket device having a camera module and a socket into which the camera module is inserted includes a cap for securing the camera module in the socket, and a buffer member for closure formed between a surface of the camera module and the cap to enclose the periphery of a lens portion of the camera module, thereby preventing malfunction of the camera module and image quality degradation due to ingress of foreign materials into the lens portion and absorbing shock forces exerted at the top of the camera module socket device.

### PRIORITY

This application claims the benefit under 35 U.S.C. §119(a) of a Korean patent application filed on Dec. 22, 2010 in the Korean Intellectual Property Office and assigned Serial No. 10-2010-0132146, the entire disclosure of which is hereby incorporated by reference.

### BACKGROUND OF THE INVENTION

1. Field of the Invention

The present invention relates to a camera module socket device. More particularly, the present invention relates to a camera module socket device for blocking a path through which foreign materials may ingress.

2. Description of the Related Art

Nowadays, a camera module is typically installed in a portable terminal as demand for capturing a moving or still image is increasing. A camera module is connected to a Printed Circuit Board (PCB) of the portable terminal by a Flexible Printed Circuit Board (FPCB) fastening method or a socket fastening method in order to perform its function, and recently the socket fastening method has been increasingly used because it may be used more easily than the FPCB fastening method.

FIG. 1 shows a cross-sectional view of a camera module socket device according to the related art.

Referring to FIG. 1, a camera module socket device 100 includes a camera module 150 and a socket 110 into which the camera module 150 is inserted. The camera module 150 includes a lens portion L located in an upper central portion thereof and a camera module PCB 170 located in the bottom thereof The socket 110 includes a locking pin 111 formed in an inner side, and a terminal 120 formed in the inner lower surface. If the camera module 150 is inserted into the socket 110 as shown in FIG. 1, the locking pin 111 engages with a locking recess 161 of the camera module 150, thereby fixing the camera module 150 to the socket 110. Additionally, the terminal 120 of the socket 110 contacts a terminal 171 formed in the camera module PCB 170 to enable an image signal or control signal to be transmitted between the camera module 150 and a controller (not shown) of the portable terminal.

There is no problem of ingress of foreign materials from the top of the camera module socket device 100 because the top of the camera module socket device 100 is enclosed by a rear cover (not shown) of the portable terminal However, there may be gaps at the bottom of the socket 110, and foreign materials may ingress into the lens portion L through the gaps along a path A of FIG. 1. Therefore, problems of malfunction and image quality degradation of a camera module may occur.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address the above-mentioned problems and/or disadvantages and to provide at least the advantages described below. Accordingly, an aspect of the present invention is to provide a camera module socket device that prevents malfunction and image quality degradation of a camera module due to ingress of foreign materials into the lens portion.

In accordance with an aspect of the present invention, a camera module socket device having a camera module and a socket into which the camera module is inserted is provided. The device includes a cap for covering the socket and the camera module that is inserted into the socket, and a buffer member for closure formed between a surface of the camera module and the cap to enclose the periphery of a lens portion of the camera module.

According to exemplary embodiments of the present invention, malfunction and image quality degradation of the camera module due to ingress of foreign materials into the lens portion may be prevented by forming a buffer member for closing a space between a surface of the camera module and a cap enclosing the periphery of the lens portion of the camera module. Additionally, shock forces exerted at the top of the camera module socket device may be absorbed by the buffer member.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 shows a cross-sectional view of a camera module socket device according to the related art;

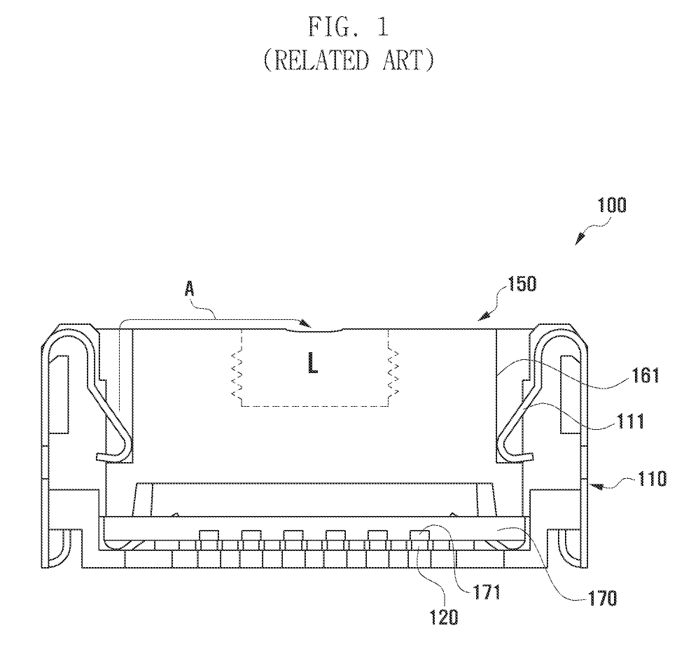

FIG. 2 shows a perspective view of a camera module socket device before fastening according to an exemplary embodiment of the present invention;

FIG. 3 shows a perspective view of the camera module socket device of FIG. 2 after fastening; and

FIG. 4 shows a cross-sectional view of the fastened camera module socket device of FIG. 3 cut along the dotted line B-B′.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

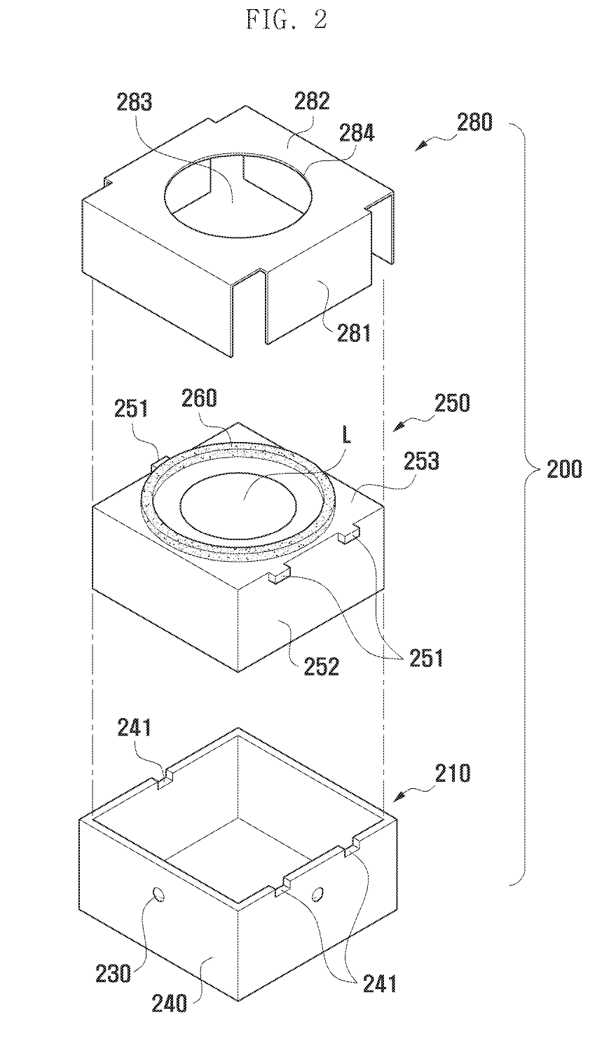

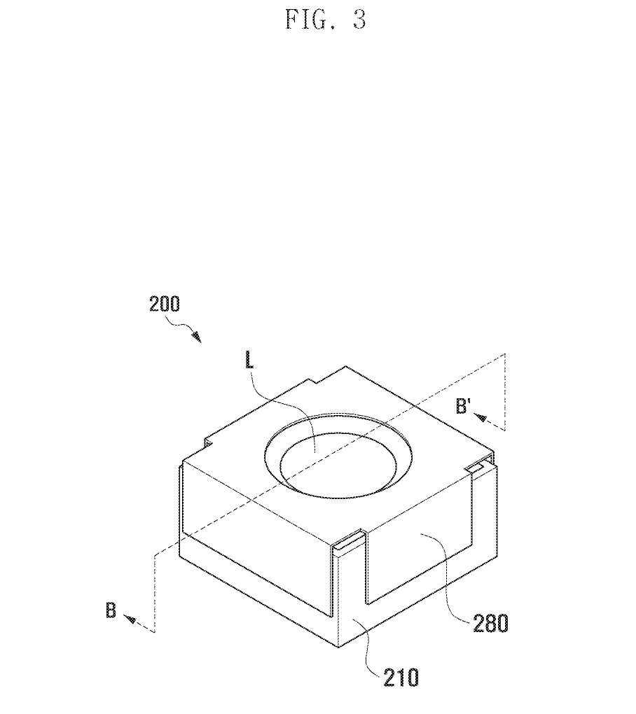

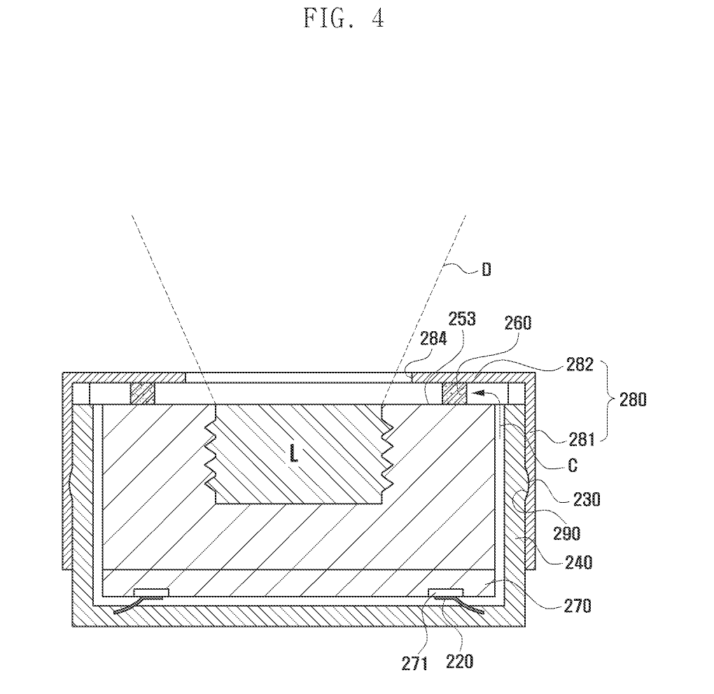

FIG. 2 shows a perspective view of a camera module socket device before fastening according to an exemplary embodiment of the present invention, FIG. 3 shows a perspective view of the camera module socket device of FIG. 2 after fastening, and FIG. 4 shows a cross-sectional view of the fastened camera module socket device of FIG. 3 cut along the dotted line B-B′. According to exemplary embodiments of the present invention, the camera module socket device may include additional and/or different components, or omit any number of the components shown in FIG. 2 through FIG. 4. Similarly, the functionality of two or more components may be integrated into a single component.

Referring to FIG. 2 through FIG. 4, a camera module socket device 200 according to an exemplary embodiment of the present invention includes a camera module 250, socket 210, cap 280, and buffer member 260 for providing closure.

The camera module 250 is a component by which a user can take a desired photograph of an object. The camera module 250 includes a lens portion L, a lens driving unit (not shown), a camera module Printed Circuit Board (PCB) 270, and protrusions 251. The lens portion L is formed in the upper central portion of the camera module 250 to collect incident light and create an image on an image sensor (not shown). The lens driving unit moves the lens portion L in a linear direction along the optical axis to adjust image focus, and is preferably a voice coil actuator formed around the lens portion L. The camera module PCB 270 is electrically connected to the image sensor to process an image signal from the image sensor in a digital form, and is formed having a terminal 271 to contact a terminal 220 of the socket 210 in order to transmit an image signal and a control signal between the camera module 250 and a controller (not shown) of the portable terminal The protrusion 251 is a component for enabling insertion of the camera module 250 into the socket 210, and is formed in a rectangular shape protruding from a side surface 252 of the camera module 250.

The socket 210 is a component into which the camera module 250 is inserted for electrically connecting the camera module 250 to the PCB (not shown) of the portable terminal The socket 210 includes the terminal 220, a groove 241, and a protrusion 230. The terminal 220 is formed in the inner lower surface of the socket 210 to contact the terminal 271 of the camera module 250 and transmit an image signal and a control signal between the camera module 250 and the controller of the portable terminal The protrusion 251 of the camera module 250 is inserted into the groove 241. The three grooves 241 shown in FIG. 2 are formed asymmetrically about the center of the socket 210. Therefore, the grooves 241 help the camera module 250 to be inserted into the socket 210 with a correct direction about the socket 210. The protrusion 230 is formed in an outer side surface 240 of the socket 210, and engages with a concave portion 290 of the cap 280.

The cap 280 is a component that covers the socket 210 and camera module 250 inserted into the socket 210 in order to secure the camera module 250 in the socket 210. The cap 280 has a top cover 282 of a rectangular shape covering the top of the camera module 250, and side covers 281 extending downwards from the four edges of the top cover 282 to cover the outer side surface 240 of the socket 210. An opening 283 is formed in the center of the top cover 282 to expose the lens portion L. An inner periphery 284 of the top cover 282 formed by the opening 283 is formed to be located outside the view angle D of the lens portion L when the cap 280 is attached to the socket 210, as shown in FIG. 4. The concave portion 290 with which the protrusion 230 of the socket 210 engages is formed in the corresponding side cover 281 of the cap 280 to fix the cap 280 to the socket 210. The camera module 250 is pushed by the top cover 282 of the cap 280 towards the socket 210 through the buffer member 260 by means of a force generated through engagement of the protrusion 230 and concave portion 290 to secure the camera module 250 in the socket 210. Although, according to an exemplary embodiment of the present invention, the protrusion 230 is formed in the outer side surface 240 of the socket 210 and the concave portion 290 is formed in the corresponding side cover 281 of the cap 280, a concave portion may be formed in the outer side surface 240 of the socket 210 and a protruding portion may be formed in a corresponding inner surface of the side cover 281 of the cap 280.

The buffer member 260 for closure is a component for blocking ingress of foreign materials to the lens portion L. The buffer member 260 is formed between an upper surface 253 of the camera module 250 and the top cover 282 of the cap 280 to enclose the upper periphery of the lens portion L of the camera module 250. The buffer member 260 is made of a material that may be deformed by pressing, such as sponge or polyurethane.

According to an exemplary embodiment of the present invention, the buffer member 260 for closure blocks a path C through which foreign materials may ingress from the bottom or side of the camera module socket device 200, as shown in FIG. 4, thereby preventing ingress of foreign materials into the lens portion L. Additionally, shock forces exerted in a situation such as being struck by a falling material may be absorbed by the buffer member 260.

While the invention has been shown and described with reference to certain exemplary embodiments thereof, it will be understood by those skilled in the art that various changes in form and details may be made therein without departing from the spirit of the invention as defined by the appended claims and their equivalents.

What is claimed is:

1. A camera module socket device having a camera module and a socket into which the camera module is inserted, the device comprising:
a cap for covering the socket and the camera module that is inserted into the socket; and
a buffer member for closure formed between a surface of the camera module and the cap to enclose the periphery of a lens portion of the camera module.

2. The device of claim 1, wherein the cap comprises a top cover that covers the top of the camera module and side covers that cover outer side surfaces of the socket.

3. The device of claim 2, wherein at least one retaining device retains the cap to the socket.

4. The device of claim 3, wherein the at least one retaining device retains at least one side cover of the cap to a corresponding outer side surface of the socket.

5. The device of claim 2, wherein a concave portion is formed on one of the side cover of the cap and the outer side surface of the socket, and a protrusion is formed on the other of the side cover of the cap and the outer side surface of the socket to engage with the concave portion.

6. The device of claim 5, wherein an opening through which the lens portion of the camera module may be exposed is formed in the center of the top cover of the cap.

7. The device of claim 5, wherein the buffer member contacts a lower surface of the top cover of the cap.

8. The device of claim 5, wherein the side covers of the cap extend downwards from the edges of the top cover of the cap.

9. The device of claim 1, wherein the buffer member is formed of a material that may be deformed by pressing.

10. The device of claim 9, wherein the material that may be deformed by pressing comprises at least one of sponge and polyurethane.

11. The device of claim 1, wherein the device is disposed in a portable terminal.

12. The device of claim 1, wherein the socket includes at least one groove into which corresponding protrusions of the camera module are inserted, when the camera module is inserted into the socket.

13. A camera module socket device, the device comprising:
a camera module including a lens;
a socket into which the camera module is inserted;
a cap for covering the socket and the camera module that is inserted into the socket, the cap including a top cover that covers the top of the camera module and side covers that cover outer side surfaces of the socket;
at least one retaining device for retaining the cap to the socket; and
a buffer member for closure formed between a surface of the camera module and the cap to enclose the periphery of the lens of the camera module, wherein the buffer member is formed of a material that may be deformed by pressing and wherein the buffer member contacts a lower surface of the top cover of the cap.

14. The device of claim 13, wherein the at least one retaining device retains at least one side cover of the cap to a corresponding outer side surface of the socket.

15. The device of claim 13, wherein the at least one retaining device comprises:
a concave portion formed on one of the side cover of the cap and the outer side surface of the socket; and
a protrusion formed on the other of the side cover of the cap and the outer side surface of the socket to engage with the concave portion.

16. The device of claim 13, wherein an opening through which the lens portion of the camera module may be exposed is formed in the center of the top cover of the cap.

17. The device of claim 13, wherein the side covers of the cap extend downwards from the edges of the top cover of the cap.

18. The device of claim 13, wherein the material that may be deformed by pressing comprises at least one of sponge and polyurethane.

19. The device of claim 13, wherein the device is disposed in a portable terminal.

20. The device of claim 13, wherein the socket includes at least one groove into which corresponding protrusions of the camera module are inserted, when the camera module is inserted into the socket.
